(19) United States
(12) Patent Application Publication
(10) Pub. No.: US 2019/0228353 A1
(43) Pub. Date: Jul. 25, 2019

(54) COMPETITION-BASED TOOL FOR ANOMALY DETECTION OF BUSINESS PROCESS TIME SERIES IN IT ENVIRONMENTS

(71) Applicant: EMC IP Holding Company LLC, Hopkinton, MA (US)

(72) Inventors: Avitan Gefen, Tel Aviv (IL); Amihai Savir, Sansana (IL); Ran Taig, Beer Sheva (IL); Shai Harmelin, Haifa (IL); Idan Levy, Rishan Lezion (IL)

(21) Appl. No.: 15/875,924

(22) Filed: Jan. 19, 2018

(51) Int. Cl. G06Q 10/06

(52) U.S. Cl. CPC G06Q 10/067; G06F 3/04842; G06Q 10/063

(57) ABSTRACT

Embodiments include detecting anomalies in an IT environment using model competition and business patterns by collecting time series data for events for the network including devices and interfaces. An analytics module uses competing time series models with customizable business patterns to find the best fit model. It analyzes the residuals of the best fitting model to find the outliers relative to normal zone data points. A user may classify a detected outlier as normal, in which case, the tracking and investigation mechanism suggests alternate business patterns to be matched against this outlier. A user interface displays a dashboard to present the user with anomalies in the chosen time series, such as in interactive graphical format.

### TECHNICAL FIELD

Embodiments are generally directed to enterprise networks, and more specifically to anomaly detection and analysis of business processes in IT environments.

### BACKGROUND

Large-scale enterprise networks and information technology (IT) operation environments host large numbers of assets required by the business for daily operations. These assets are monitored by different service response requirements on a periodic basis, such as from once every second to once a quarter or more. Understanding unusual behavior of assets in the environment is crucial for the operation of the business, but it is not a trivial task, especially when there are numerous assets that interconnect with one another. One of the fundamentals steps analysts use in monitoring health and troubleshooting of outages is an outlier/anomaly discovery mechanism for time-series analysis.

Current tools for finding anomalies, however, are either manually used by experts or utilize limited automated techniques, such as using only one method versus multiple approaches. This can result in too many false-positives, and lack the ability to capture business concepts and patterns. Present methods also lack the ability to give automatic suggestions for business patterns that will eliminate false-positives in the future. These restrictions prevent managers from making the best decisions, given the most recent information in a highly dynamic environment and with limited human resources, such as the IT operation of the modern businesses. In many cases, decision makers abandon the monitoring tools capability to detect anomalies because of high false positive error rates.

Finding outliers or anomalies in a time-series is generally an unsupervised task in nature; that is, there are usually no tagged outliers and there is no good way to measure the accuracy of any outlier discovery algorithm. As with many unsupervised tasks, the answer is also subjective in that different people will give different answers, and it depends on the topology/scale, in that the length of the time series may change the classification of an outlier. In addition, classifying data points as outliers for past data is not the same as trying to do it on the edge of the time series (the most recent data points). Moreover, in a business environment, an obvious outlier may be regarded as a non-outlier if this behavior is anticipated, such as an ad-hoc large backup that affects normal systems behavior. Finally, the business environment itself may introduce behaviors that could follow patterns that are not easy to model, like performing a monthly backup on the first Saturday of the month that follows at least one work day, for example.

As IT operation environments house a large number of assets required by the business for daily operations, subject matter experts (SMEs) and chief information officers (CIOs) require a comprehensive view of the environment behavior. An SME that works with state-of-the-art time series tools could find the right tool with the right parameters for the job when asked for, but this generally requires trying several tools, which is slow, especially if they need to analyze and investigate which business pattern influences the signal and incorporate it in the model. At present, SMEs may use existing tools such as VCOPS, Splunk, and Log-Insight to investigate outliers and look separately at each time series set of data or aggregated log counts to find numerical anomalies. In addition, there are many open source tools and packages that find anomalies in a time series. One such tool requires one to state the percentage of anomalies beforehand, while another is a complicated package with many options that requires manual labor. Both of these methods do not have the native capability to incorporate business environment behavior patterns without substantial manual labor. A review of present possible solutions has revealed that none focus on the business pattern detection as a means to reduce the errors or to automate the fitting of the anomaly detection model.

What is needed, therefore, is an anomaly detection scheme for time series patterns that corresponds to clear business behaviors and processes as business patterns. An advantageous process identifies these common patterns and leverages them to make the anomaly detection mechanism accurate by better recognizing what events are normal versus not normal.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

### BRIEF DESCRIPTION OF THE DRAWINGS

In the following drawings like reference numerals designate like structural elements. Although the figures depict various examples, the one or more embodiments and implementations described herein are not limited to the examples depicted in the figures.

FIG. 1 illustrates an enterprise-scale network system with devices that implement one or more embodiments of a business process anomaly detector, under some embodiments.

FIG. 2 illustrates the main functional components and/or processes of the anomaly detector of FIG. 1, under some embodiments.

FIG. 3 is a flow chart that illustrates a process of competing time series models with customizable business patterns, under some embodiments.

FIG. 4 illustrates the use of a box-plot technique to represent outliers, under some embodiments.

FIG. 5 illustrates a time series display with a normal zone and outliers, under some embodiments.

FIG. 6 is a flowchart that illustrates a method of detecting anomalies in an IT environment using model competition and business patterns, under some embodiments.

FIG. 7 is a block diagram of a computer system used to execute one or more software components of an anomaly detector, under some embodiments.

### DETAILED DESCRIPTION

A detailed description of one or more embodiments is provided below along with accompanying figures that illustrate the principles of the described embodiments. While aspects of the invention are described in conjunction with such embodiments, it should be understood that it is not limited to any one embodiment. On the contrary, the scope is limited only by the claims and the invention encompasses numerous alternatives, modifications, and equivalents. For the purpose of example, numerous specific details are set forth in the following description in order to provide a thorough understanding of the described embodiments, which may be practiced according to the claims without some or all of these specific details. For the purpose of clarity, technical material that is known in the technical fields related to the embodiments has not been described in detail so that the described embodiments are not unnecessarily obscured.

It should be appreciated that the described embodiments can be implemented in numerous ways, including as a process, an apparatus, a system, a device, a method, or a computer-readable medium such as a computer-readable storage medium containing computer-readable instructions or computer program code, or as a computer program product, comprising a computer-usable medium having a computer-readable program code embodied therein. In the context of this disclosure, a computer-usable medium or computer-readable medium may be any physical medium that can contain or store the program for use by or in connection with the instruction execution system, apparatus or device. For example, the computer-readable storage medium or computer-usable medium may be, but is not limited to, a random-access memory (RAM), read-only memory (ROM), or a persistent store, such as a mass storage device, hard drives, CDROM, DVDROM, tape, erasable programmable read-only memory (EPROM or flash memory), or any magnetic, electromagnetic, optical, or electrical means or system, apparatus or device for storing information. Alternatively, or additionally, the computer-readable storage medium or computer-usable medium may be any combination of these devices or even paper or another suitable medium upon which the program code is printed, as the program code can be electronically captured, via, for instance, optical scanning of the paper or other medium, then compiled, interpreted, or otherwise processed in a suitable manner, if necessary, and then stored in a computer memory. Applications, software programs or computer-readable instructions may be referred to as components or modules. Applications may be hardwired or hard coded in hardware or take the form of software executing on a general-purpose computer or be hardwired or hard coded in hardware such that when the software is loaded into and/or executed by the computer, the computer becomes an apparatus for practicing the invention. Applications may also be downloaded, in whole or in part, through the use of a software development kit or toolkit that enables the creation and implementation of the described embodiments. In this specification, these implementations, or any other form that the invention may take, may be referred to as techniques. In general, the order of the steps of disclosed processes may be altered within the scope of the described embodiments.

Some embodiments of the invention involve large-scale IT networks or distributed systems (also referred to as “environments”), such as a cloud based network system or very large-scale wide area network (WAN), or metropolitan area network (MAN). However, those skilled in the art will appreciate that embodiments are not so limited, and may include smaller-scale networks, such as LANs (local area networks). Thus, aspects of the one or more embodiments described herein may be implemented on one or more computers in any appropriate scale of network environment, and executing software instructions, and the computers may be networked in a client-server arrangement or similar distributed computer network.

As stated above, large-scale networks having large numbers of interconnected devices (“resources” or “assets”) often exhibit unusual or abnormal behavior due to a variety of fault conditions or operating problems. Finding the significant events that can help determine the root cause of such behavior is often a time and labor-intensive process requiring the use of specialized personnel and/or sophisticated analysis tools. Also important is distinguishing anomalous events and differentiating true problem events from abnormal events that actually represent unusual but valid business operations/processes or other non-problematic reason.

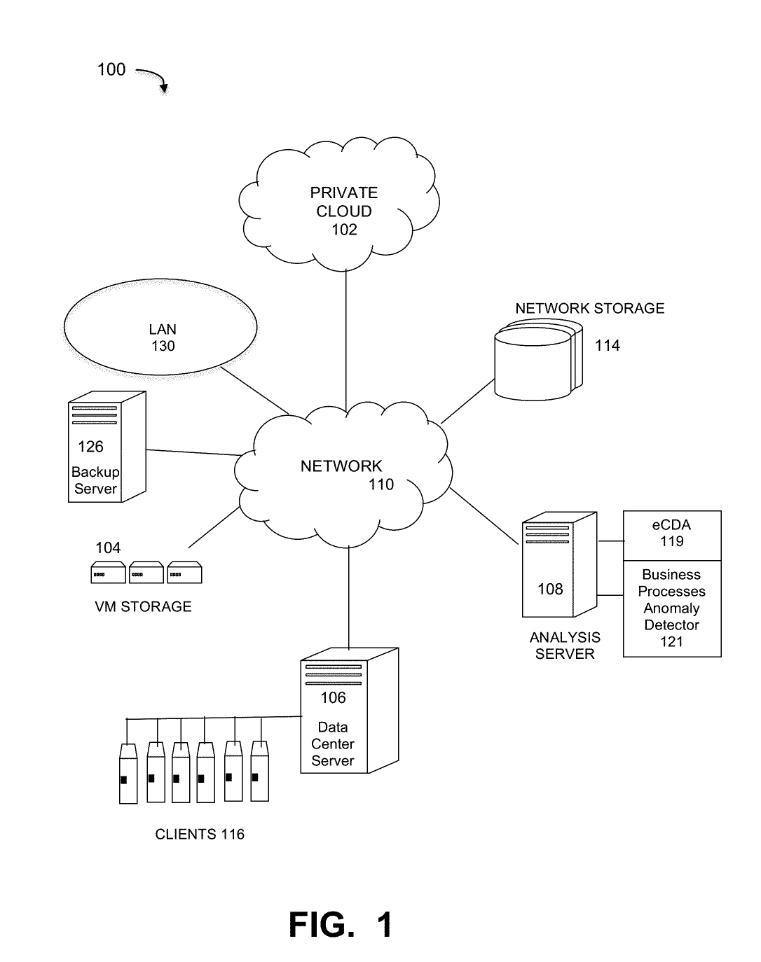

FIG. 1 is a diagram of a network implementing an anomaly detector for business processes in enterprise-scale networks or similar IT environments, under some embodiments. In network environment 100 various different resources such as LAN (or WAN) networks 130 and cloud networks 102 are coupled to other resources through a central network 110. Various different applications can be supported by system 100, such as a data backup system in which case a backup server 126 may execute a backup management process that coordinates or manages the backup of data from one or more data sources, such as other servers/clients to storage devices, such as network storage 114 and/or virtual storage devices 104. With regard to virtual storage 114, any number of virtual machines (VMs) or groups of VMs (e.g., organized into virtual centers) may be provided to serve as backup targets. The VMs or other network storage devices serve as target storage devices for data backed up from one or more data sources, which may have attached local storage or utilize networked accessed storage devices 114.

The network server computers are coupled directly or indirectly to the target VMs, and to the data sources through network 110, which is typically a cloud network (but may also be a LAN, WAN or other appropriate network). Network 110 provides connectivity to the various systems, components, and resources of system 100, and may be implemented using protocols such as Transmission Control Protocol (TCP) and/or Internet Protocol (IP), well known in the relevant arts. In a cloud computing environment, network 110 represents a network in which applications, servers and data are maintained and provided through a centralized cloud computing platform. In an embodiment, system 100 may represent a multi-tenant network in which a server computer runs a single instance of a program serving multiple clients (tenants) in which the program is designed to virtually partition its data so that each client works with its own customized virtual application, with each VM representing virtual clients that may be supported by one or more servers within each VM, or other type of centralized network server.

Although embodiments are described and illustrated with respect to certain example implementations, platforms, and applications, it should be noted that embodiments are not so limited, and any appropriate network supporting or executing any application may utilize aspects of the anomaly detection process described herein. Furthermore, network environment 100 may be of any practical scale depending on the number of devices, components, interfaces, etc. as represented by the servers and clients and other elements of the network.

FIG. 1 generally represents an example of a large-scale IT operation environment that contains a large number of assets required by the business for daily operations. These assets are monitored by different response requirements, from every second to once a month or quarter, or more. Understanding unusual behavior of assets in the environment is crucial for the operation of the business, but can be complicated when there are numerous assets that feed each other or are connected in various ways. As stated above, different tools are available for analysts to investigate outliers in the system behavior, such as VCOPs, Splunk, Log-Insight, and so on. Present analysis methods typically involve an analyst (SME) using a single program or tool to find anomalies, which may result in an excessive number of false positives.

In an embodiment, network system 100 includes an analysis server 108 that executes an anomaly detector 121 that detects anomalies, unusual behavior, outages, or other problems exhibited by any of the components in system 100. The anomaly detector 121 is configured to automatically discover time series outliers of the IT/business environment, which can be integrated into IT decision support system. The solution will allow IT executives to get a dynamic health status of the network environment 100, providing the means to automate processes based on the stage of the business cycle, as well as generate alerts and notifications when attention is needed. This is accomplished by leveraging competing state-of-the-art time series models with customizable business constraints and patterns to ensure highest accuracy and low false-positive alerts. While the anomaly detection method may be unsupervised, the user can analyze and review a potential outlier to find if it is real or not. The most suitable model is used to deduce the normal expected behavior, and subsequently, the difference between the expected behavior and the actual signal (the residuals) is what exposes the anomalies. Embodiments also allow for the investigation of possible new business patterns if needed, when the user believe the outliers found follow some pattern. The process 121 uses a standard method for visualizing a discovery mechanism that aims at explaining the severity of the outlier by enveloping an area called the “normal-zone” where the signal is not considered an anomaly. The signal outside this area is considered as an outlier.

The anomaly detector 121 may be embodied as a hardware component provided as part of analysis server 108 as a programmable logic circuit, such an FPGA, ASIC, or other similar hardware module. Alternatively, it may be embodied as a program executed by processors and processing hardware of analysis server 108. It may also be embodied as firmware integrating aspects of both hardware and software (executable program) elements residing in or executed by processors and circuitry of analysis server 108. In yet a further embodiment, anomaly detector 121 may be partially or wholly executed by or integrated within one or more other servers of system 100. It may also be partially or wholly embodied as a server-side, client-side, or distributed (server-client) component or process within one or more processor-based elements of system 100.

As shown in the example system of FIG. 1, the anomaly detector 121 described herein may be used with or as part of an Enterprise Copy Data Analytics (eCDA) program 119 as the decision support system, which is a cloud analytics platform that provides a global view into the effectiveness of data protection operations and infrastructure. This platform provides a global map view displaying current protection status for each site in a simple-to-understand and compare score. Enterprise CDA leverages historical data to identify anomalies and generate actionable insights to more efficiently optimize a protection infrastructure. Other decision support systems are also possible.

In an embodiment, the process 121 denotes time series patterns that correspond to clear business behaviors and processes as business patterns. It identifies these common patterns and leverages them to make the anomaly detection mechanism accurate by recognizing better what is normal behavior versus what is not. Business patterns can be defined appropriately, such as by schedule, task milestones, and so on. Further examples will be provided below.

Unlike present solutions, which rely on the use of a single anomaly detection method, embodiments of the present method use an ensemble-based approach (such as used in related fields like predictive modelling and forecasting) and applies a competition among different methods of anomaly detection. The competition is conducted between state-of-the-art methods and time series models. The consideration of many different methods and models improves event classification accuracy by reducing false positives and false negatives. This is important because different time-series may be “captured” better or worse by different methods. The best model is used to deduce the normal expected behavior, and subsequently, the difference between that and the actual signal (the residuals) is what exposes the anomalies. Therefore, the better the model, the less wrong the anomaly classifications will be. Embodiments also incorporate customizable business behavior patterns in the competing models. This framework allows customization, such as in choosing a subset of desired patterns from existing ones, or the ability to add new patterns as needed.

Business patterns can be defined specifically depending on the requirements of the network application or environment. For example, a typical business pattern is stated in terms of scheduling, such as workday/weekend/holiday, or a bit more complex such as first/ . . . /last weekend (or Friday/Saturday) of the month/quarter/year. Night hours in the weekend (for hourly data) or weekday and so on. Once identified, the best fit business pattern will be revealed to the user so that they can validate the selection or suggest others. Embodiments may also include a business pattern suggestion and investigation tool. If the user wishes to label an outlier as non-outlier, such as because it repeats itself in some pattern-like fashion, the system can suggest a business pattern to be matched against the outlier. The benefit for the user is that the system will automatically treat what was detected and classified to be an outlier as normal in the future. In general, but business patterns processed herein are repeated in some way versus being one-time events, and commonly involve time series repetitive events, although other types of repetitive events may also be involved.

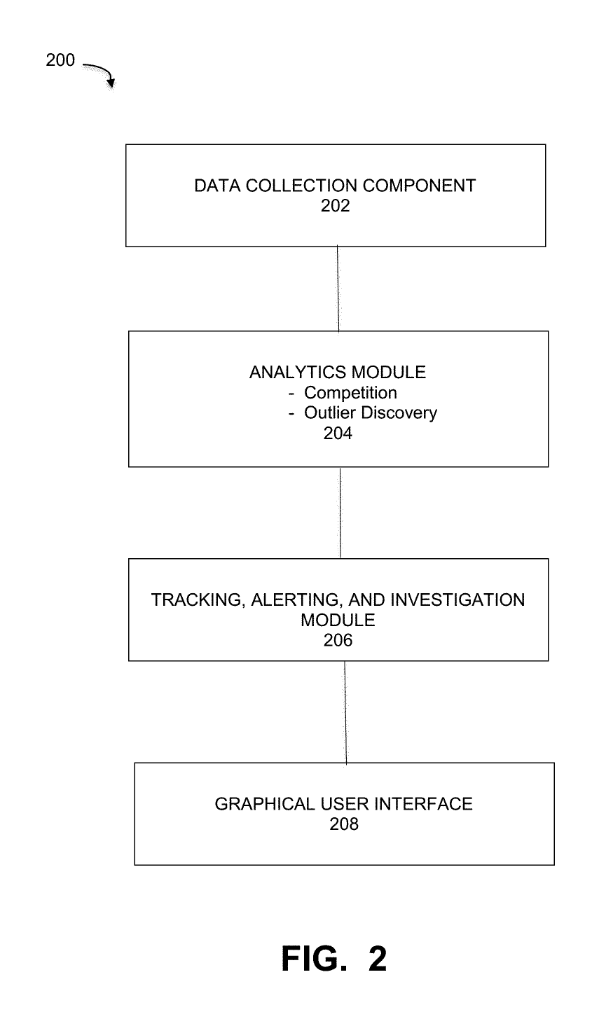

FIG. 2 illustrates the main functional components and/or processes of the anomaly detector 121 of FIG. 1, under some embodiments. As shown in diagram 200, the main components include a near real-time data collection component 202, an analytics module 204 having competing time series models with customizable business patterns and normal-zone and outlier discovery, a tracking, alerting and investigation component 206, and a user interface 208. The platform and solution of FIG. 2 enables system administrators and personnel to get an accurate picture of the health of the overall system in addition of exposing anomalies and outliers that require further investigation and actions. In addition, it can help improve the total customer experience, by giving the customers an automated alerts and monitoring system that will empower them to easily realize the health of their environment.

As used herein, the term “time series” refers to a series of data points listed or graphed in time order. It can be a sequence of discrete-time data taken at successive equally spaced points in time. In the context of an IT network, the data can comprise any appropriate network metric, such as data throughput, processor cycles, memory access, I/O transactions, program executions and so on. Time series analysis comprises methods for analyzing time series data in order to extract meaningful statistics and other characteristics of the data; and time series forecasting is the use of a model predict future values based on previously observed values. Regression analysis is often employed in such a way as to test theories that the current values of one or more independent time series affect the current value of another time series. Embodiments are not so limited, however, and other similar analysis methods may be used.

As shown in diagram 200, the data collection component 202 may implement an agent process that is deployed to collect data from the assets. The agents may be provided by the assets, such as data protection appliance (DPA) or eCDA agents, or they may be network agents that monitor transactions between the agents. Alternatively, data collection may be performed based on processes that are provided as part of the agents themselves. For example, storage and protection assets may be configured to send data regarding their status to manufacturers or other parties on a regular basis or on a defined frequency, such as every five minutes an appliance may send CPU, memory, daily capacity samples etc., to the companies that made them. Other appropriate data collection processes are also possible. The collected data is parsed and stored in centralized data store. The collected data contains relevant information about the assets such as ingest rate, usage, utilization, compressed data, data retention, replication, garbage collection, and other performance metrics.

The analytics module 204 of system 200 comprises two main functional components, a competition component that manages competing time series models with customizable business patterns, and a normal-zone/outlier discovery module. The competition component monitors the health of the overall system 100 by analyzing different assets and performance metrics. The module does so by tracking time-series data from the assets/devices of the system and analyzing them for outlier detection. In an embodiment, outlier detection is done for historical data points and on the edge (present or latest) data points. To get a low number of false-positive alerts, it conducts a fitting competition between methods and models. This is desirable, since no one method or model is capable of handling all kinds of time-series. This process may be unsupervised, but the user can analyze and review the potential outlier to find if it is real or not.

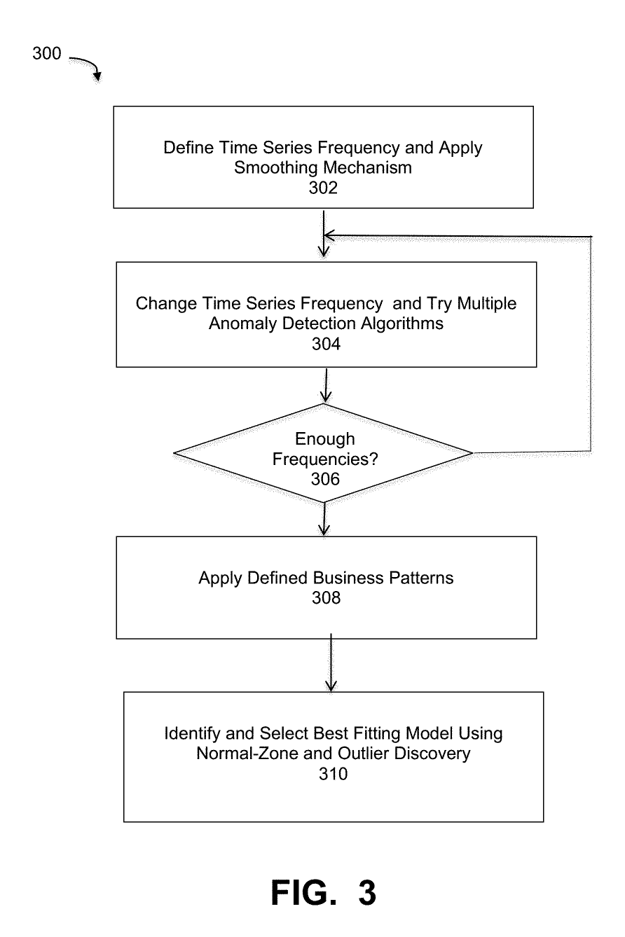

Operation of the competition model is described below in the context of processing a daily generated signal, though embodiments apply to signals of other periodicity, such as intra-day (hourly), weekly, by the minute, and so on. FIG. 3 is a flow chart that illustrates a process of competing time series models with customizable business patterns as used in analytics module 204, under some embodiments. In step 302, the process 300 defines a time series frequency unit or periodicity with respect to a defined time scale. For the example of a daily generated signal, the time unit would be one day, so the frequency unit is set as f=1. With this base frequency unit, there is no seasonality, so the process applies a smoothing mechanism to smooth the signal. Any appropriate smoothing mechanism may be used, such as moving-average or LOESS (e.g., locally weighted scatterplot smoothing).

Once the time series frequency unit is defined, various different anomaly detection methods are tested against different series frequencies in order of changing frequencies, 304. For each iteration, the frequency is changed and different time-series models are tested. For example, the frequency of the time series can be set to f=7, which is a weekly seasonality for a daily signal. For this frequency, various different time-series models, can be used to model the time series and test its fit. Smoothing may also be performed for the different time series frequencies, such as for the cases where no strong seasonality exists.

In an embodiment, appropriate time-series models can include STL, ARIMA (autoregressive integrated moving average), ETS, Holt-Winters and others can be used. The models could be selected from a set of possible models, or a default model or set of models to be tried in turn can be defined. This case can then be repeated for a monthly frequency, f=30, or any different period of days (e.g., f=10, f=100, etc.) or even parts of days f=1/24 (hourly), for example. Any appropriate frequency periods can be used and tested depending on application requirements and system constraints. Thus, the time series model trial step 304 is attempted a number of times until it is determined that enough frequencies are tried, 306.

With respect to time series modeling and anomaly detection, a time series model is a function that represents the nature of the time series. A function is said to be better if the difference between the model and the actual time series is small. After choosing a model that best represents a time series, a large difference between the model and the time series suggests an anomalous event. For example, in the case of a perfect model, any difference between the model and the time series suggests that something strange happened. However, the such a difference may be an acceptable event rather than a problem condition. Thus, as shown in FIG. 3, the process 300 next considers the problem of business environment patterns, 308.

This method framework 300 allows customization regarding choosing a subset of desired business patterns from existing ones, or the ability to add new patterns as needed. Business patterns can be of any defined measure, such as simple or complex scheduling (e.g., workday/weekend/holiday or first/last weekend of the month/quarter/year, and so on). These patterns can be captured using time-series methods that can handle exogenous variables, such as Arimax or other multivariate methods. In an embodiment, business patterns are modeled in a particular range in a time series that may be different to the other time series. The business patterns can be tested iteratively for different possible business patterns. For a number of possible business patterns, all or only a subset of business patterns may be chosen for modeling and best fit analysis.

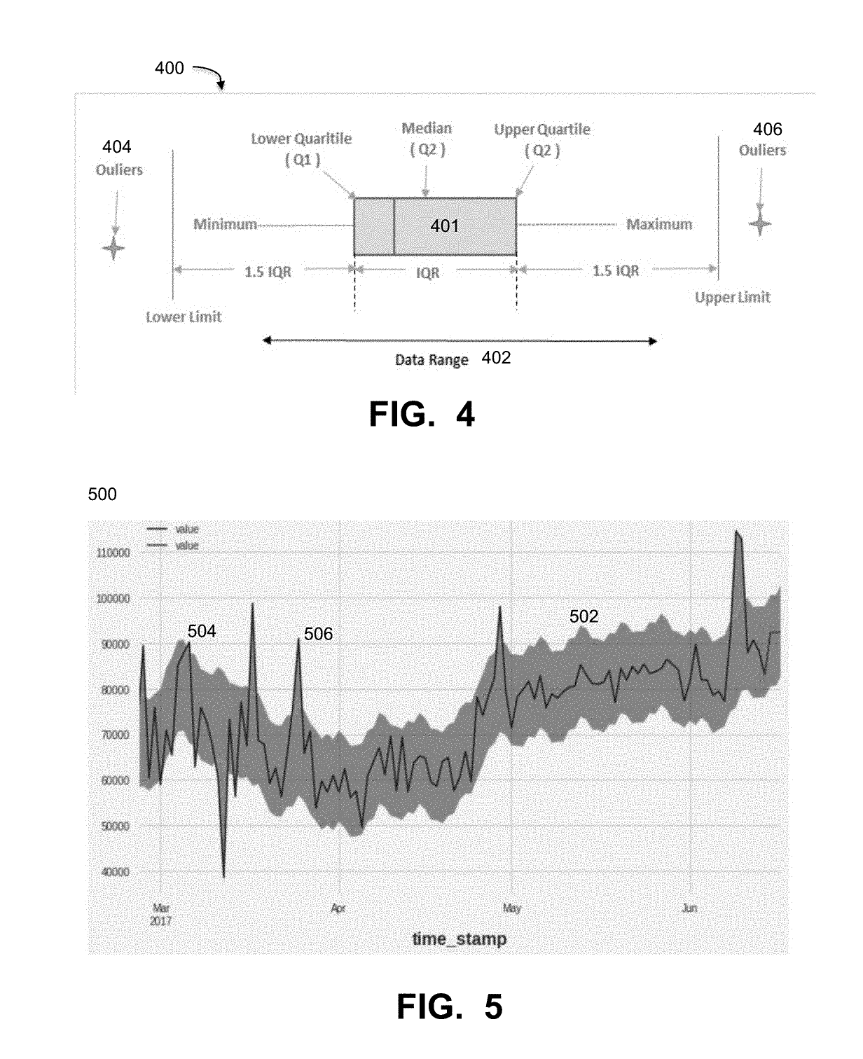

The best fitting model from all the trialed models (including the subset of the chosen business patterns) is then identified and selected, step 310. In an embodiment, the best fit is computed by means of accuracy using a statistical fitting function like SSE (sum of squared errors), MSE (mean squared error), MAE (mean absolute error), or similar methods. To find the outliers and produce the normal-zone region for events, the process analyzes the residuals of the best fitting model from the actual signal. Several techniques can be applied on the residuals population to establish which residuals represent an outlier, such as Gaussian model, box-plot and so on. FIG. 4 illustrates the use of a box-plot technique to represent outliers, under some embodiments. In general, a box plot s a standardized way of displaying the distribution of data based on the five-number summary: minimum, first quartile, median, third quartile, and maximum, and is a convenient way of visually displaying groups of numerical data through their quartiles.

As shown in FIG. 4, box plot 400 defines a data range 402 that has a lower limit and an upper limit. Once the residuals boundaries are established, like the lower and upper limits in FIG. 4, the process can declare which residual is anomalous and represent an outlier data point, such as outliers 404 and 406. The normal zone 401 will then be established by adding the lower and upper limits to the fitting model, and the outside areas are where outliers are located. The user can adjust the sensitivity of this discovery mechanism if desired.

FIG. 5 illustrates an example time series display with a normal zone and outliers, under some embodiments. As shown in plot 500 of FIG. 5, a base time series is shown as a dark line plot 504 surrounded by a normal zone area 502. The y-axis of plot 500 is a range of the values of the time series. The outlier region 506 is shown as the region extending outside of the normal zone 502, and is typified by sharp tall peaks or valleys in the time-series plot. The illustrated display output of FIG. 5 is intended to be an example only, and embodiments are not so limited. Any appropriate graph format and time-dependent parameter (y-axis) for the time series data may be used depending on the network environment and application.

With respect to the tracking, alerting, and investigation module 206 of FIG. 2, the user is free to run the analytics module for any given period, e.g., monthly, quarterly, yearly, etc. They can choose the sensitivity of the discovery mechanism and decide if they wish to get alerts for new outliers. If the user wishes to label an outlier as non-outlier, such as because it repeats itself in some pattern-like fashion, the system can suggest a business pattern to be matched against the outlier. The benefit for the user is that the system will automatically treat a previously identified outlier as normal in the future. The suggestions can come from a predefined set or using an investigation mechanism. For example, a GUI process may be used to tag events on the graph for display as different tags on a calendar that would allow a user to see if there is a scheduling pattern. Thus, such a mechanism can be configured to show the outliers on a calendar (for daily signal) or one of the top of the other for hourly signals, with the ability to add and remove days as needed, including focusing on certain days, and so on.

A brute-force patterning (using all possible patterns) is not used for several reasons. First, the time-series involved can be relatively short (like a daily signal of 1-3 months). For this kind of time series, it is best not to overload the multivariate methods with too many variables. Secondly, trying many potential patterns raises the probability that it will wrongly match a pattern.

As shown in FIG. 2, a user interface 208 presents to the user a dashboard for presenting the user with the anomalies in the chosen time series. The process augments the discovery mechanism with a visualization that aims at explaining the severity of the outlier by using an area called the normal-zone 401 which envelopes the area in which the signal is not an anomaly, as shown in FIG. 4. The signal outside this area is considered as an outlier (e.g., 404, 406). The system also offers the user to interact with the outlier to give them labels or to get automated suggestions of business patterns that may change the classification of the outlier. In this embodiment, the user interface presents to the user the time series charts with labels on top of it to provide an interactive chart that connects the outliers (in contrasting display such as color or pattern) to the events. The graph is interactive so that the user can click on the tag labels to access further information about the event itself, such as event description, data source and timestamp.

For large-scale networks, it has been found that a single anomaly detection method or time-series model is not enough to capture the possible business patterns of an IT environment. Embodiments include imposing a competition between models, including those that can capture business patterns is the best approach to increase accuracy and allow for the best customer experience.

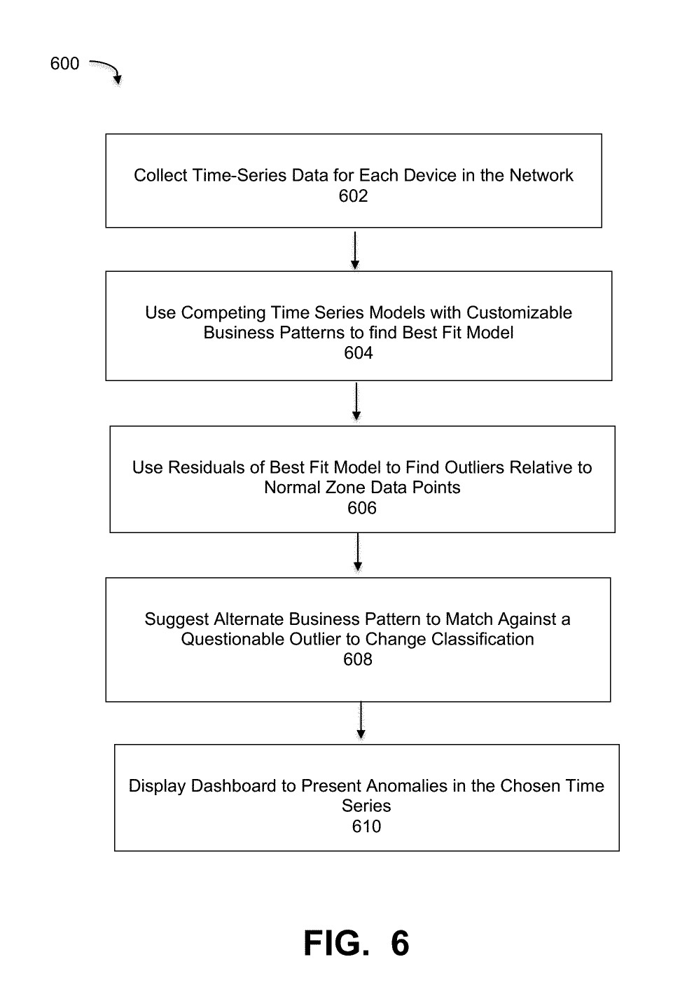

FIG. 6 is a flowchart that illustrates an overall method of detecting anomalies in an IT environment using model competition and business patterns, under some embodiments. Process 600 starts by collecting time series data for events for the network including some or all of the devices and interfaces, 602. The analytics module 204 then uses competing time series models with customizable business patterns to find the best fit model, 604. It then analyzes the residuals of the best fitting model to find the outliers relative to normal zone data points, 606. This can be performed using Gaussian or Box-Plot methods, and the like. A user may wish to classify a detected outlier as normal, in which case, the tracking and investigation mechanism 206 can suggest alternate business patterns to be matched against this outlier, 608. The user interface 208 then displays a dashboard to present the user with anomalies in the chosen time series, 610. Such a GUI presentation may be provided in an interactive list, calendar, or graphical form, such as shown in FIG. 5.

### Detecting Anomalies

With respect to the time series anomaly detection module, there are several known ways to find anomalies in a time series that can be used in alternative embodiments. Anomaly detection for time series typically involves finding outlier data points relative to a standard (usual or normal) signal. There can be several types of anomalies and the primary types include additive outliers (spikes), temporal changes, and seasonal or level shifts. Anomaly detection processes typically work in one of two ways. First, they label each time point as an anomaly or non-anomaly; second, they forecast a signal for some point and test if the point value from the forecast by a margin defining it as an anomaly. In an embodiment, any anomaly detection method may be used including STL (seasonal-trend decomposition), classification and regression trees, ARIMA modeling, exponential smoothing, neural networks, and other similar methods.

Some anomaly detection methods employ smoothers of the time-series while others use forecasting methods. For detecting an outlier on the edge of a time series (the newest point), forecasting methods are generally better suited. In an embodiment, the anomaly detection process 204 conducts a competition between different forecasting models and chooses the one that performs the best on a test data set, i.e., the one that has the minimal error. The best model is used for forecasting, and the difference between the actual value and the predicted one is calculated and evaluated. If the residual is significantly larger when comparing to the residual population the process declares the event to be an anomaly. This method also detects unexpected changes in trend or seasonality, where seasonality refers to the periodic fluctuations that may be displayed by time series, such as backup operations increasing at midnight. The process can also be configured to assign weights for the anomalies based on the significance of the residual for a weighted calculation.

### System Implementation

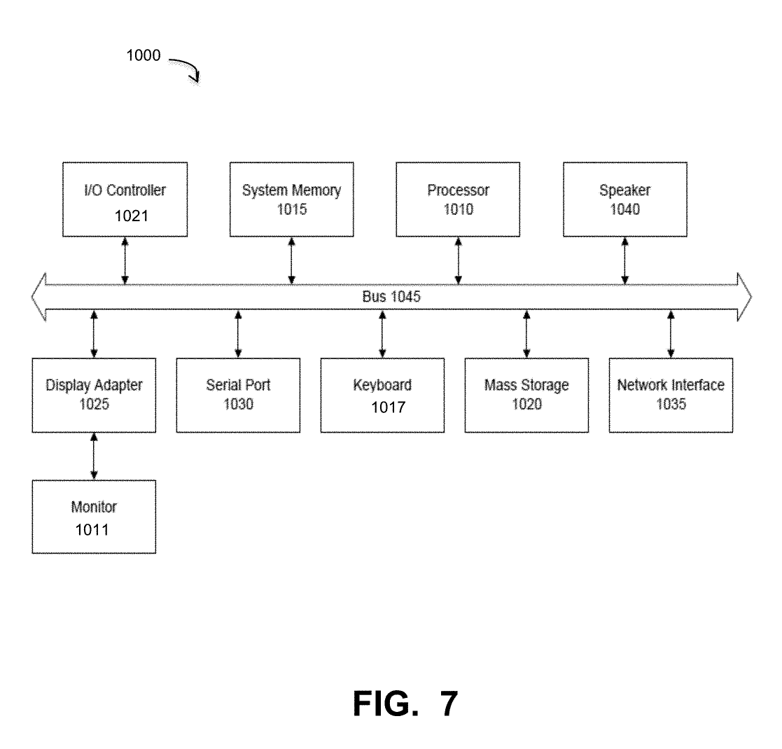

As described above, in an embodiment, system 100 includes an anomaly detector 121 that may be implemented as a computer implemented software process, or as a hardware component, or both. As such, it may be an executable module executed by the one or more computers in the network, or it may be embodied as a hardware component or circuit provided in the system. The network environment of FIG. 1 may comprise any number of individual client-server networks coupled over the Internet or similar large-scale network or portion thereof. Each node in the network(s) comprises a computing device capable of executing software code to perform the processing steps described herein. FIG. 7 is a block diagram of a computer system used to execute one or more software components of an anomaly detector, under some embodiments. The computer system 1000 includes a monitor 1011, keyboard 1017, and mass storage devices 1020. Computer system 1000 further includes subsystems such as central processor 1010, system memory 1015, input/output (I/O) controller 1021, display adapter 1025, serial or universal serial bus (USB) port 1030, network interface 1035, and speaker 1040. The system may also be used with computer systems with additional or fewer subsystems. For example, a computer system could include more than one processor 1010 (i.e., a multiprocessor system) or a system may include a cache memory.

The processor 1010 is generally configured to execute program modules that comprise all or some of the software programs that may include processes described herein when they are embodied as software. Other components of system 1000, such as may be incorporated as part of processor 1010 or accessed vial interfaces 1030 or 1035 may include programmable elements or circuits (ASICS, programmable arrays, etc.) that are wired or configured to embody the functions provided by the components and processes described herein.

Arrows such as 1045 represent the system bus architecture of computer system 1000. However, these arrows are illustrative of any interconnection scheme serving to link the subsystems. For example, speaker 1040 could be connected to the other subsystems through a port or have an internal direct connection to central processor 1010. The processor may include multiple processors or a multicore processor, which may permit parallel processing of information. Computer system 1000 shown in FIG. 7 is an example of a computer system suitable for use with the present system. Other configurations of subsystems suitable for use with the present invention will be readily apparent to one of ordinary skill in the art.

Computer software products may be written in any of various suitable programming languages. The computer software product may be an independent application with data input and data display modules. Alternatively, the computer software products may be classes that may be instantiated as distributed objects. The computer software products may also be component software. An operating system for the system may be one of the Microsoft Windows®. family of systems (e.g., Windows Server), Linux, Mac OS X, IRIX32, or IRIX64. Other operating systems may be used. Microsoft Windows is a trademark of Microsoft Corporation.

Although certain embodiments have been described and illustrated with respect to certain example network topographies and node names and configurations, it should be understood that embodiments are not so limited, and any practical network topography is possible, and node names and configurations may be used. Likewise, certain specific programming syntax and data structures are provided herein. Such examples are intended to be for illustration only, and embodiments are not so limited. Any appropriate alternative language or programming convention may be used by those of ordinary skill in the art to achieve the functionality described.

Embodiments may be applied to data, storage, industrial networks, and the like, in any scale of physical, virtual or hybrid physical/virtual network, such as a very large-scale wide area network (WAN), metropolitan area network (MAN), or cloud based network system, however, those skilled in the art will appreciate that embodiments are not limited thereto, and may include smaller-scale networks, such as LANs (local area networks). Thus, aspects of the one or more embodiments described herein may be implemented on one or more computers executing software instructions, and the computers may be networked in a client-server arrangement or similar distributed computer network. The network may comprise any number of server and client computers and storage devices, along with virtual data centers (vCenters) including multiple virtual machines. The network provides connectivity to the various systems, components, and resources, and may be implemented using protocols such as Transmission Control Protocol (TCP) and/or Internet Protocol (IP), well known in the relevant arts. In a distributed network environment, the network may represent a cloud-based network environment in which applications, servers and data are maintained and provided through a centralized cloud-computing platform.

For the sake of clarity, the processes and methods herein have been illustrated with a specific flow, but it should be understood that other sequences may be possible and that some may be performed in parallel, without departing from the spirit of the invention. Additionally, steps may be subdivided or combined. As disclosed herein, software written in accordance with the present invention may be stored in some form of computer-readable medium, such as memory or CD-ROM, or transmitted over a network, and executed by a processor. More than one computer may be used, such as by using multiple computers in a parallel or load-sharing arrangement or distributing tasks across multiple computers such that, as a whole, they perform the functions of the components identified herein; i.e., they take the place of a single computer. Various functions described above may be performed by a single process or groups of processes, on a single computer or distributed over several computers. Processes may invoke other processes to handle certain tasks. A single storage device may be used, or several may be used to take the place of a single storage device.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

All references cited herein are intended to be incorporated by reference. While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method of identifying an anomaly in a network having a server computer, comprising:
collecting, in a data collector, time series data for devices of the network;
selecting a plurality of available time series models to analyze the time series data with respect to predict future values based on previously observed values;
running, in an analytics module of the server computer, each selected time series model on the time series data with customizable business patterns to find a best fit model of the selected time series models;
analyzing, in the analytics module, residuals of the best fit model to find the outliers in the time series data relative to normal zone data points; and
displaying, through a graphical user interface of the server computer, a graphical representation of the time series data highlighting the outliers.

2. The method of claim 1 further comprising:
receiving an indication that a selected outlier should be reclassified as a normal data point;
suggesting, through a tracking and investigation component of the server computer, an alternative business pattern to be matched against the selected outlier.

3. The method of claim 2 wherein the alternative business pattern is selected through one of a predefined set of business patterns or through the use of an investigation mechanism.

4. The method of claim 1 wherein the residuals of the best fit model are analyzed using one of a Gaussian method or a box-plot method.

5. The method of claim 1 wherein the time series data is written to a central data store, and comprises information relevant to devices and interfaces of the network including: data ingest rate, data usage, resource utilization, data compression, data retention, data replication, and garbage collection.

6. The method of claim 5 wherein the time series data comprises log information collected by one of: an agent process embedded in each device of the network, or automatic status transmitting mechanisms native to each device.

7. The method of claim 1 wherein the available time series models comprise: STL, ARIMA, ETS, and Holt-Winters models.

8. The method of claim 7 further comprising:
defining a base time series frequency unit in which no seasonality is exhibited;
applying a smoothing process to the time series data for a frequency equal to the base frequency unit;
iteratively running each selected time series model on the time series data for increasing multiples of the base frequency unit until a defined maximum multiple is reached; and
identifying the best fit model by minimal residuals after the iterative running.

9. The method of claim 8 wherein the time series frequency unit comprises one of: hour, day, week, and month.

10. The method of claim 1 wherein the business pattern comprises a schedule dictating occurrence of data points comprising events and the outliers.

11. The method of claim 10 further comprising defining a normal zone in the time series data as including events not classified as outliers.

12. A system of detecting anomalies in a network having a server computer, comprising:
a data collector of the server computer collecting time series data for devices of the network;
a component selecting a plurality of available time series models to analyze the time series data with respect to predict future values based on previously observed values;
an analytics module running each selected time series model on the time series data with customizable business patterns to find a best fit model of the selected time series models, and analyzing residuals of the best fit model to find the outliers in the time series data relative to normal zone data points; and
a graphical user interface displaying a graphical representation of the time series data highlighting the outliers.

13. The system of claim 12 wherein the business pattern comprises a schedule dictating occurrence of data points comprising events and the outliers.

14. The system of claim 13 further comprising a tracking and investigation component receiving an indication that a selected outlier should be reclassified as a normal data point, and suggesting, through of the server computer, an alternative business pattern to be matched against the selected outlier, and wherein the alternative business pattern is selected through one of a predefined set of business patterns or through the use of an investigation mechanism.

15. The system of claim 1 wherein the time series data is written to a central data store, and comprises information relevant to devices and interfaces of the network including: data ingest rate, data usage, resource utilization, data compression, data retention, data replication, and garbage collection.

16. The system of claim 12 wherein the analytics module further defines a base time series frequency unit in which no seasonality is exhibited, applies a smoothing process to the time series data for a frequency equal to the base frequency unit, iteratively runs each selected time series model on the time series data for increasing multiples of the base frequency unit until a defined maximum multiple is reached, and identifies the best fit model by minimal residuals after the iterative running.

17. The system of claim 16 wherein the time series frequency unit comprises one of: hour, day, week, and month, and wherein the available time series models comprise: STL, ARIMA, ETS, and Holt-Winters models.

18. The system of claim 12 wherein the analytics component further defines a normal zone in the time series data as including events not classified as outliers.

19. A computer program product, comprising a non-transitory computer-readable medium having a computer-readable program code embodied therein, the computer-readable program code adapted to be executed by one or more processors to perform a method of detecting anomalies in a network having a server computer, the method comprising:
collecting, in a data collector, time series data for devices of the network;
selecting a plurality of available time series models to analyze the time series data with respect to predict future values based on previously observed values;
running, in an analytics module of the server computer, each selected time series model on the time series data with customizable business patterns to find a best fit model of the selected time series models;
analyzing, in the analytics module, residuals of the best fit model to find the outliers in the time series data relative to normal zone data points; and
displaying, through a graphical user interface of the server computer, a graphical representation of the time series data highlighting the outliers.
